(19) United States
(12) Patent Application Publication
(10) Pub. No.: US 2003/0108046 A1
(43) Pub. Date: Jun. 12, 2003

(54) Interface device

(76) Inventor: John B. Simeone, Toronto (CA)

Correspondence Address: RICHES, MCKENZIE & HERBERT, LLP, SUITE 1800, 2 BLOOR STREET EAST, TORONTO, ON, M4W 3J5, CA

(21) Appl. No.: 10/003,104

(22) Filed: Dec. 6, 2001

(51) Int. Cl. H04L 12/56

(52) U.S. Cl. 370/395.1; 370/466

(57) ABSTRACT

An interface device for interfacing user devices to an asynchronous transfer made (ATM) network is disclosed. The interface device facilitates interfacing a number of different types of user devices to the ATM network. The interface device comprises input/output units to interface with a number of user devices. The interface device also contains a power conversion module to provide power to the input/output units and other elements, as well as store energy so that the interface device can function, at least partially, during a system failure or power failure. The interface device is electrically and logically insulated from the user devices, such as workstations or host computers, to facilitate at least partial functioning during a system failure or power failure. The interface device also provides a natural speech processor to convert natural language into computer recognizable language at a location near the user device. The interface device also provides for a gate keeping function to assist in detecting and discontinuing unusual transactions.

### FIELD OF THE INVENTION

This invention relates to interface devices for converting signals from a user device to a network. More particular, this invention relates to an interface device that can be used to interface a plurality of different types of user devices to an asynchronous transfer mode (ATM) network.

### BACKGROUND OF THE INVENTION

In the past, there have been a variety of internal local area communication systems for communication of information from different types of user devices to and from a plurality of networks including internal data networks, video distribution systems, video security systems and the public switched telephone network (PSTN). However, most of the internal communication systems utilized in the past have relied on a private branch exchange (PBX) for connection of the internal local area communication system to the public switched telephone network (PSTN) to send and receive information through the public telephone system. Private branch exchanges have been used in the past because of its reliability in transferring information to the public switched telephone network (PSTN). Data networks have incorporated a collection of hubs, switches and routers to transmit data internally and to and from internal and external networks, such as the Internet. Video distribution and security have required separate hardware systems.

This requirement of unique hardware for each network type makes for very complex internal communications systems. Such systems suffer from the disadvantage that each network requires its own communications interfaces and medium to transfer signals to and from user devices within the individual networks. Moreover, there is very little or limited communication capabilities between the disparate networks.

The prior art has made attempts to converge voice, video and data networks. However, most have focused on carriage of voice and video over packet data networks. Within this framework little attempt has been made to reduce overall system complexity and the quantity of hardware or to incorporate existing user telephone devices. In fact, a new, additional device, the public switched telephone network (PSTN) gateway, has been introduced to bridge the data network and the PBX. In this model the PBX remains the critical component that provides mission critical, lifeline connectivity to the public switched telephone network.

For example, FIG. 1 illustrates a conventional legacy communication system comprised of separate data, voice and video networks, shown generally by reference numeral 1. The legacy system 1 utilizes a variety of hubs 5, switches 4 and routers 6 to connect users 10 into a local data network, as well as other data networks such as the Internet and Global VPN through a Firewall 7, and a PBX 2 to connect users 10 to the public switched telephone network (PSTN). As is also apparent, the fax 11 and voice mail 12 components of the internal legacy system, shown in FIG. 1, are connected separately to the PBX.

However, there is a need in the art for an internal communication system that can more efficiently and easily connect different types of user devices through the public switched telephone networks and data networks. In addition, there is a need in the art for an interface device that can easily, efficiently, and robustly connects a plurality of different types of user devices to a common unit which can then transfer information to the public switched telephone network. There is also a need in the art for an internal communication system that can survive, and function at least partially, during a power failure or a system failure. There is also a need in the art for an interface device that can assist in detecting and preventing denial of service attacks and other malicious network interference such as worms and viruses that may result in a denial of service.

### SUMMARY OF THE INVENTION

Accordingly, it is an object of this invention to at least partially overcome the disadvantages of the prior art. Also, it is an object of this invention to provide an improved type of communication system and improved type of interface device that can transfer signals from a plurality of different types of user devices through an internal communication system to the public switched telephone network. It is also an object of the present invention to provide an interface device that can be reliably connected to a user device and survive, and preferably partially function, through a failure of the user device, or, a general power failure.

Accordingly, in one of its aspects, this invention resides in an interface device for interfacing a user device to an asynchronous transfer mode (ATM) network, said interface device comprising a user input/output unit for receiving and sending user communication signals to and from the user device; an ATM network input/output unit for receiving and sending network signals to and from the ATM network; a microprocessor for converting said user signals to network signals and converting network signals to user signals; and wherein the interface device is powered by a power source which is not dependent on the user device or the ATM network.

In a further aspect, the present invention resides in an interface device for interfacing a user device to a network, said interface device comprising a user input/output unit for receiving and sending user communication signals to and from the user device; network input/output unit for receiving and sending network signals to and from the network; a microprocessor for converting said user signals to network signals and converting network signals to user signals; and wherein the interface device is powered by a power source which is not dependent on the user device or the network.

One advantage of the present invention is that the interface device is completely self-contained and can operate independently of the user device. In this way, the interface device can survive a power loss of the user device. The interface device can also comprise read-only memory (ROM) upon which can be stored software to boot the interface device in the event of a power loss or other catastrophic failure of either the interface device or the user device.

A further advantage of the present invention is that it can monitor transactions to and from the user devices. This assists in detecting unusual activity that would result in denial of service to the user or the entire system. The interface device can also implement instructions that limit or deny access to specific ports or user devices to assist in protecting the system against denial of service attacks. In other words, the interface device can act as a gatekeeper to protect the system.

A further advantage of the present invention is that the interface device can comprise a self-configuring unit that can identify the nature of the telephonic unit attached to the interface device. The self-configuring unit can also determine the nature of the voltage and commands which must be sent to interface with the telephonic unit and configure the interface unit to interface with the telephone unit.

A further advantage of the present invention is that, in one embodiment, the interface device provides for natural language recognition and processing at a location near the user device. In this way, the context sensitive natural language speech processing can be accomplished close to the user. This provides the advantage that the communication signals from the user in natural language can be converted to computer recognizable language, such as hypertext mark up language (HTML) or extended mark up language (XML), at an implementation point close to the user and the user device. This improves the quality of the conversion from natural language to computer recognizable language by avoiding the noise phase shifting, frequency distortion and quantization error introduced by the limited bandwidth of telephone transmission systems.

A similar advantage is provided when computer recognizable language is sent to the user from a distant location. By converting the computer recognizable language into natural language at an implementation point located close to the user and the user device, there is less degradation of the natural language communication signals generated from the computer recognizable language because of the limited distance the converted natural language communication signals must travel from the point of conversion to the ultimate user. This is significant because natural language communication signals generated from computer recognizable language are generally not of high quality and any further degradation should be avoided.

Further aspects of the invention will become apparent upon reading the following detailed description and drawings that illustrate the invention and preferred embodiments of the invention.

### BRIEF DESCRIPTION OF THE DRAWINGS

In the drawings, which illustrate embodiments of the invention:

FIG. 1 shows a conventional internal communication system utilizing a PBX to connect the internal communication system to the public switched telephone network;

FIG. 2 shows an internal communication system according to one embodiment of the present invention for connecting user devices to the public switched telephone network;

FIG. 3 is a block diagram of a network interface device according to one embodiment of the present invention; and

FIG. 4 is a block diagram of a natural speech processor (NSP) component of the network interface device shown in FIG. 3.

### DETAILED DESCRIPTION OF THE PREFERRED EMBODIMENTS

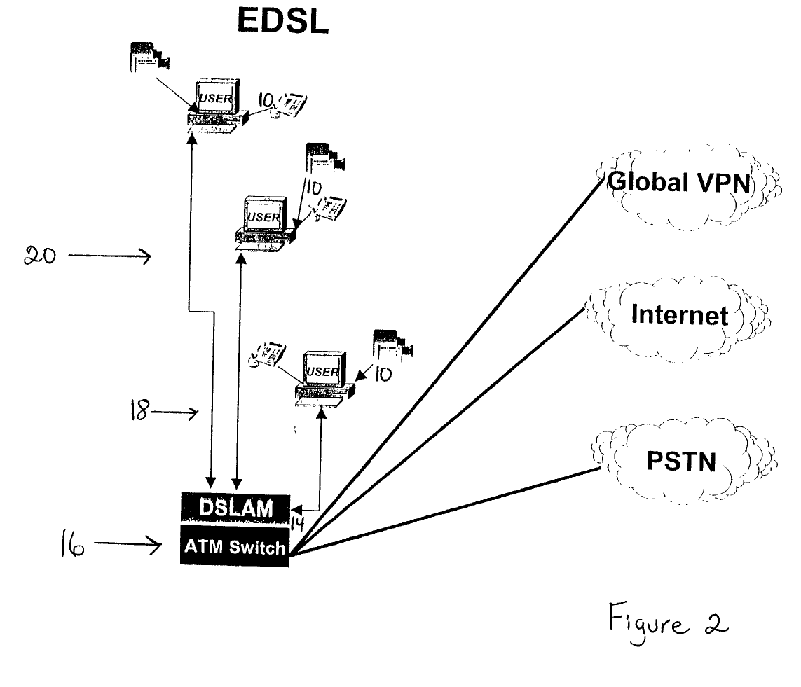

As shown in FIG. 2, one embodiment of the present invention relates to a system, shown generally by reference numeral 20, for connecting a plurality of users or user devices 10, to an asynchronous transfer mode (ATM) network 18. The ATM network 18 will have an ATM connection 16 that acts as a switch to connect the network 18 to other networks. These other networks can include the public switched telephone network (PSTN), the Internet and a global virtual private network (VPN), and other networks including Ethernet networks.

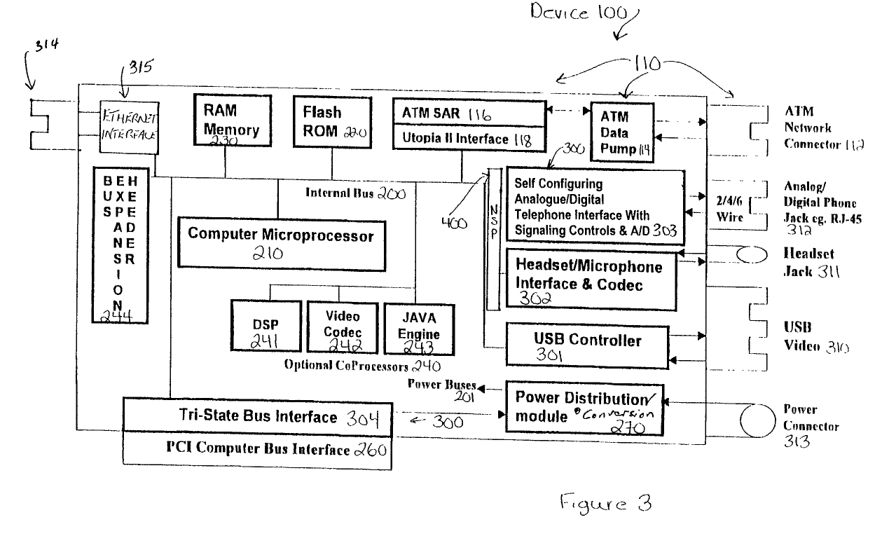

Each user 10 would have an interface device, shown generally by reference numeral 100 in FIG. 3. Each user 10 would have an ATM network interface 100 for connection to the ATM network 18. Preferably, a digital subscriber line access multiplexer (DSLAM) 14 is located between each of the network interface devices 100 connected to the users 10 and the ATM connection 16 to external networks. The DSLAM 14 facilitates transfer of communication signals to and from the network interface devices 100 on each user 10 and the ATM connection 16 that, in turn, permits connection between the users 10.

In one embodiment, the present invention provides an interface device 100 for use in the system 20 to provide a robust, distributed converged network 18 that mimics the functions of conventional PBX networks. To achieve this, each of the interface devices 100 is preferably equipped with software for performing user network interface (“UNI”) signalling, such as UNI 4.0 signalling. Utilizing this signalling, either directly through the ATM switch 16 or a DSLAM 14 acting as a UNI signalling proxy, an interface device 100 is able to establish voice telephone connections from its attached telephone, in cases where the user device 10 is a telephone, to one or more telephones on other interface devices 100 or telephones situated anywhere on the world-wide public switched telephone network (PSTN). The quality of these connections will be indistinguishable in quality from one using the same telephone instrument through a conventional PBX. From two or more telephones connected to interface device 100 any number of digital transmission formats may be employed to encapsulate and transmit the voice over the network. For connections to one or more telephones on the PSTN, the choice of one or more particular coding systems, fifty six or sixty four kilobit per second pulse code modulation (56k/64k PCM) allows the interface device 100 to connect to any type of telephone carrier facilities, including DS1, T1, T3, DS3, ES1, ES3, supplied by local and long distance telephone carriers throughout the world to their customers.

To perform this distributed PBX function, it is preferred that the following three characteristics be present. Firstly, the interface device 100 preferably has access to a directory service, such as light weight directory access protocol, (“LDAP”), to provide mapping from telephone number addressing to the internal network service access point (“NSAP”) address required by the interface device 100. To provide reliability, this directory service may, itself, be distributed throughout the network 18. Secondly, preferably there exists within the network 18 a service that manages signalling to and from the PSTN. This service preferably serves as a proxy to execute PSTN signalling functions on behalf of the interface devices 100, distributes in-bound telephone connection requests from the PSTN and manages the overall availability of specific channels with all carrier facilities, such as DS3, connected to the ATM switch 16. This PSTN proxy service may provide both in-band and out-of-band signalling services or relegate in-band signalling to the interface device 100. Thirdly, ATM switch 16, or other hardware device, is capable of mapping specific channels, such as (DS0s), within the carrier facility, such as DS1, DS3, to specific NSAP addresses.

Within the ATM network 18, quality of service connections may be established with voice only, video only or voice and video. Except for the required bandwidth, the system 20 makes no distinctions between voice and video.

In a further preferred embodiment, each of the interface devices 100 contains software to provide universal messaging facilities including voice, video and fax mail. This messaging system is designed to interact with standards based email systems.

A further preferred feature of this system is the fact that any interface device 100, may, with proper programming of the PSTN signalling proxy service, substitute for a particular interface device 100 to provide universal messaging services. In other words, should a particular interface device 100 be unavailable for any reason, another interface device 100 could receive and store the message until retrieved either directly by the user or automatically when the previously unavailable interface device 100 becomes available.

There also exists in this system 20 the potential to associate a specific telephone number not with specific telephone handsets or interface devices 100 but with a specific individual. In this way the telephone number is associated with the NSAP address of the interface 100 connected to the computer on which the individual has performed a logon.

Some other features that lend to the robustness of the system 20 include that the interface device 100 is capable of powering the telephone handset for at least the length of a workday. This means that the system 20 will continue operating even if there are severe power supply disruptions. Furthermore, there is no single point of failure in the system 20. Services such as the directory services and universal messaging services are highly distributed. Others such as the SS7/ISDN proxy signalling service are located within the ATM switch or maybe provided by redundant equipment through soft permanent virtual circuits managed by the ATM switch. This adds to the robustness of the system 20 by providing because the failure of no one component in the system 20 can cause a general system 20 failure. In addition, for the interface devices 100, all other equipment such as the ATM switch 16/DSLAM 14, computer servers may be centrally located and physically and electrically protected.

FIG. 3 illustrates a schematic diagram of the interface 100 according to one embodiment of the present invention. The ATM network interface device 100 comprises an ATM network input/output unit, shown generally by reference numeral 110. The ATM network input/output unit 110 comprises an ATM network connector 112, an ATM data pump 114, an ATM segmentation and reassembly unit (SAR) 116 and a Utopia II interface 118.

As is known in the art, the ATM connector 112 is a connector for physically connecting the ATM network interface device 100 to the ATM network 18, shown in FIG. 2. The ATM network controller 112 is connected to the ATM data pump 114. The ATM data pump 114 takes the ATM cells and includes filters and hybrids which are equipped to interface between the physical medium upon which the ATM network 18 transfers ATM cells and the ATM SAR 116. In other words, the ATM data pump 114 pushes or pulls ATM cells onto or from the physical medium upon which the ATM network 18 is constituted. The ATM network 18 can be constituted, for example, on two-wire unshielded twisted copper pairs (UTP), but could also be constituted on four-wire UTP copper, CAT 5 wire, coaxial cable, optical fibre or wireless communication.

The ATM cells are then transferred to the ATM SAR 116 that segments or reassembles blocks of voice, video or data into and from 53 byte ATM cells. It is understood that while the present invention is described in terms of the preferred embodiment where 53 byte ATM cells are used, any other type of communication signals to communicate blocks of voice, video or data to and from a network can also be used. The ATM SAR 116 may also manage the traffic of ATM cells into and out of the interface device 100 through the ATM network connector 112 to fulfill the quality of service requirements for ATM transmission systems.

The ATM SAR 116 is then optionally connected to a Utopia II interface 118. The Utopia II interface 118 facilitates conversion of the ATM cells or some other data pump device to send the data extracted from the ATM cells onto an internal bus 200. It is understood, however, that the Utopia II interface 118 is not an essential component of the device 100, and rather the ATM SAR 116 can transfer the information extracted from the ATM cells directly onto the internal bus 200 of the device 100.

The internal bus 200 is connected to a computer microprocessor 210. The computer microprocessor 210 controls the functionality of the interface device 100, as will be more fully described below. The internal bus 200 also connects the microprocessor 210 to a flash read-only memory (ROM) 220. The flash ROM 220 is preferably a read-writable persistent memory module that will not lose its contents during a power loss or system failure. Preferably, the flash ROM 220 is capable of being re-written so as to modify its contents in the field in order to correct errors or add new functionality. The flash ROM 220 also contains the necessary program code and data to restart the computer microprocessor 210 from a “cold boot”, such as starting from a powered off state, either at an initial start or as may result from a power failure or catastrophic system failure.

The microprocessor 210 is also connected through the internal bus 200 to the RAM memory 230. The RAM memory 230 stores high-speed memory for the microprocessor 210. The internal bus 200 also connects the microprocessor 210 and the RAM memory 230 to other optional coprocessors 240 which may or may not be contained in the device 100. The optional coprocessors 240 may include a digital signal processing (DSP) coprocessor 241, a video codec coprocessor 242 or a JAVA engine coprocessor 243. With advances in the art of semiconductor manufacturing it is understood that any of the components 230, 240 to the microprocessor 210 is connected may be integrated into the microprocessor 210.

The digital signal processing (DSP) coprocessor 241 optionally provides additional computation power for digital signal processing. Likewise, the video codec coprocessor 242 provides additional video processing computation power and the JAVA engine coprocessor 243 provides additional JAVA byte code processing which may be required for proper functioning of the device 100 and certain multimedia application and/or other peripheral devices.

The optional coprocessors 240 can be implemented either in unpopulated sockets on a motherboard containing the other components of the interface device 100, or, on a daughterboard plugged into the motherboard, such as through the bus expansion header 244. It is understood that all of the optional coprocessors 240, and any additional coprocessors 240 which may be connected to the internal bus 200 through the bus expansion header 244, may send and receive data to and from the microprocessor 210 and the other components of the device 100. In particular, it is understood that the RAM memory 230 may store data and program code necessary for the functioning of the processor 210, as well as the optional coprocessors 240, whether they are implemented in sockets on the motherboard or connected through the bus expansion header 244.

The microprocessor 210 is also connected to the user input/output units, shown generally by reference numeral 300. The user input/output units 300 can send and receive user communication signals to and from any type of user device 10. In a preferred embodiment, the device 100 comprises three different user input/output units, namely a universal serial bus (USB) controller 301 for connection to USB video, a headset/microphone interface and codec unit 302 to provide an electrical interface for stereo headset and microphone through an appropriate analogue or digital interface, and a self configuring analogue and digital telephone interface with signalling controls and analogue/digital (A/D) codec 303.

The USB controller 301 is a universal serial bus controller and can be used to transfer serial data to any type of user device 10. In this particular embodiment, the USB controller 301 is shown electrically coupled to a USB video connector 310 for connection to a video source. However, it is understood that the USB controller 301 can be connected to any other type of device, such as external CD-ROM drives, printers, modems, mice and keyboards.

The headset/microphone interface and codec 302 is connected to a headset jack 311. The headset jack 311 can be connected to any type of headset and/or microphone. The headset/microphone interface and codec 302 also provides appropriate analogue to digital interface depending on the type of headset jack 311.

A self-configuring telephone interface with signalling controls and A/D codec 303 is connected to a phone jack 312 for connection to a telephone device (not shown). It is understood that the phone jack 312 can be any type of A/D phone jack, such as an RJ-45, but is not limited to this type of phone jack. Furthermore, a digital phone jack 312 can be a two, four, six or other type of wire interface. In a preferred embodiment, the self configuring telephone interface 303 provides all necessary voltages for operation of analogue or digital phones, including, if necessary, a 48 volt dc signal required to power and a 90 volt AC signal to ring analogue telephones.

The self-configuring telephone interface with signalling controls and A/D codec 303 provides the core telephonic interface for the network interface device 100. In particular, the self-configuring telephone interface 303 will configure to a number of manufacturer's modules of analogue and/or digital telephones. In a preferred embodiment, the self configuring telephone interface 303 contains circuitry which, under computer microprocessor 210 control, will self configure depending on the nature of the telephone connected to the digital phone jack 312. In other words, the self configuring telephone interface 303, in a preferred embodiment, and under microprocessor control, can sense characteristics of the telephone connected to the digital phone jack 312. By then accessing pre-stored data in the flash ROM 220 or locally in a computer microprocessor 210, the self configuring telephone interface 303 and the microprocessor 210 will then determine the nature of the telephone connected to the digital phone jack 312 and self configure itself to the connected telephone (not shown) by automatically adapting and sending signals to and from the connected telephone in the format required by the connected telephone. In a preferred embodiment the headset/microphone interface and codec 302 will perform a similar function with respect to any type of headset or microphone connected to the headset jack 311.

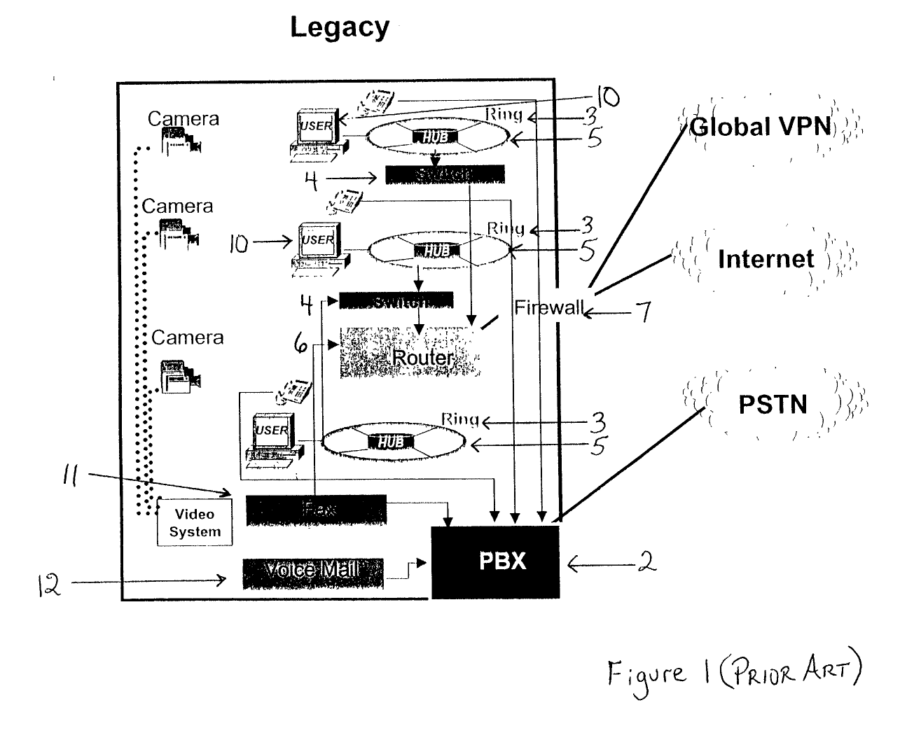

It is understood that the input/output units 300 can be any type of input/output unit required to interface with a user device 10, and is not limited to the input/output units illustrated in FIG. 3, such as the USB controller 301, the headset/microphone interface and codec 302 and the self-configuring telephone interface 303. Rather, any type of input/output unit 300 could be used. It is also understood that reference to the user 10 in FIGS. 1 and 2 is intended to refer to a user operable device 10. Therefore, it is understood that the interface device 100 can be used to interface any type of user device 10 to the ATM network 18. In a preferred embodiment, one such user device 10 would include a workstation or other type of personal computer (not shown). Such a workstation or personal computer (not shown) is preferably connected through a particular type of input/output unit 300, namely a tri-state bus interface 304, which connects to the peripheral component interconnect (PCI) bus interface 260 of a workstation or personal computer.

In a preferred embodiment, the device 100 is electrically and logically insulated from the user device 10. While this is easily achieved with user devices 10 such as telephones or USB video, electrically insulating the device 100 from a PCI bus interface 260 is more problematic. In a preferred embodiment, the device 100 comprises the tri-state bus interface 304 which can be electrically and logically disconnected from the internal bus 200, thereby electrically and logically disconnecting the PCI computer bus interface 260 from the device 100 in the event a power failure or other system failure sent on the PCI bus of the workstation or host computer (not shown) connected to the PCI computer bus interface 260. Preferably, the tri-state bus interface 304 is controlled by the microprocessor 210, and, the microprocessor 210 electrically and logically disconnects the tri-state bus interface 304 by sending a control signal if a power failure or other system failure is sensed on the PCI computer bus interface 260. In a preferred embodiment, the microprocessor 210 periodically monitors the data being sent and received by the PCI computer bus interface 260 to locate or attempt to identify system failures and/or power failures to disconnect the tri-state bus interface 304 from the PCI computer bus interface 260.

In a further preferred embodiment, the microprocessor 210 monitors the data being sent and received on the ATM network connector 112. The microprocessor 210 can do so for a number of reasons such as to determine if one of the particular units attached to the internal bus 200 has malfunctioned or is not responding. However, in a further preferred embodiment, the microprocessor 210 monitors for unusual transactions that are “out of the ordinary”. Such unusual transactions include transmitting a large number of electronic mail transmissions in a short period of time indicating a potential worm or virus is present. Unusual transactions could also include receipt of an electronic mail transmission, attachment or IP packet having a signature of a known virus or worm. Such unusual transactions could include a TCP connection that is open but nothing has been sent. In other words, if the connection has been opened and is just idling, or, the transaction is never completed. This may be an indication that either unit 10 has malfunctioned, or more importantly, the user 10 is the subject of, or originating, a denial of service attack.

In a denial of service attack, unauthorized software overloads the system 20 in order to cause a failure. One form of such overloading includes opening up a connection, but not sending any information, but rather allowing the connection to idle. For instance, a transaction is initiated, but never completed. This causes the entire system 20 to waste time and resources in a non-productive manner, which can, eventually, cause components of the system 20, or the entire system 20 to fail. Accordingly, in a preferred embodiment, the computer microprocessor 210 monitors the transaction on the ATM network connector 112 to each of the units 10 and either sends a signal to the system administrator if one or more unusual transactions are detected, or, executes code in response to identification of one or more unusual transactions.

The code that may be executed could include shutting down a gate or port such as one of the connections 304, 313. The actions may also be advising the system administrator of periodic, but not potentially catastrophic events, so that a record is kept.

It is understood that the precise response of the computer microprocessor 210 can either be stored locally in the RAM memory 230 or the Flash ROM 220. Alternatively, the responses may be sent from the system administrator to the ATM network connector 112.

In a further preferred embodiment, the invention may comprise an Ethernet interface 315 connected to an Ethernet connector 314. The Ethernet connector 314 can be any type of connector for connecting to an Ethernet network, such as an RJ45 Jack similar to the Analog/Digital Phone Jack 312. In this way, different types of user devices 10 can be connected through an Ethernet connector 314 to the interface device 100 and communicate on the ATM network connector 112. For instance, a computer notebook (not shown) could be connected to the interface device 100 through the Ethernet connector 314, rather than through the USB video connector 310.

To simplify installation in systems 20 where legacy (trade mark) workstations are equipped with an Ethernet connector, the legacy workstations can be connected to the interface device 100 through the Ethernet connection 314, thereby eliminating the need to install the interface device 100 within the workstation. This installation would work because the interface device 100 would be interposed between the user device 10 and the rest of the system 20 allowing the interface device 100 to interface the Ethernet network with the rest of the system 20. For example, the interface device 100 could be implemented with logic that introduced a priority hierarchy to information packets flowing between the Ethernet connector 314 and the ATM network connector 112. In this way, time-sensitive traffic, such as video conferencing or video-on-demand content can be flowed through the interface device 100 first, before data from other user devices 10 connected to the other connections 310 to 313, is transferred. This introduces a “quality of service” differentiation between the various user devices 10 connected to the interface device 100. This also permits the quality of service demands of an Ethernet network to be satisfied even if the user device 10 is not equipped with MPLS or another Ethernet “quality of service” protocol.

Additionally, the microprocessor 210 may make a logical performance of known Ethernet hardware interface devices. In this way, the interface device 100 can act as a transparent interface for user devices 10, specifically computer workstations, but for which the manufacturer of the user device 10 may not have developed a device driver for a particular operating system. In this way, the interface device 100 may increase the versatility of the entire system 20 by providing logic that mimicked the logical performance of known Ethernet hardware interface devices.

In a further preferred embodiment, in order to further provide robust operation of the device 100, the device 100 comprises a power distribution/conversion module 270. The power module 270 is connected to a power connector 313 which can be connected to an external power source (not shown). The power module 270 that is then distributed to the electrical elements in the device 100 by the power buses 201 receives power entering through the power connector 313. For ease of illustration, the power buses to each of the components are not separately shown.

In a preferred embodiment, the power module 270 comprises a separate power storage device, such as a battery or fuel cell, to store electrical energy for use in the event of a power failure. This permits essential elements in the device 100, such as the self-configuring telephone interface 303, the computer microprocessor 210 and the ATM network input/output unit 110 to continue functioning during a power failure. In this way, at least telephonic connections can continue even if there is a power failure. To facilitate telephone communications outside of the ATM network 18, the ATM connection 16 preferably comprises an uninterruptible power supply (UPS) (not shown). In this way, the device 100 can provide at least partial functioning during a power failure and/or system failure. It is understood that the power module 270, if the power storage permits, could also supply power to other elements, such as the headset/microphone interface and codec 302 and the USB controller 301, during a power failure.

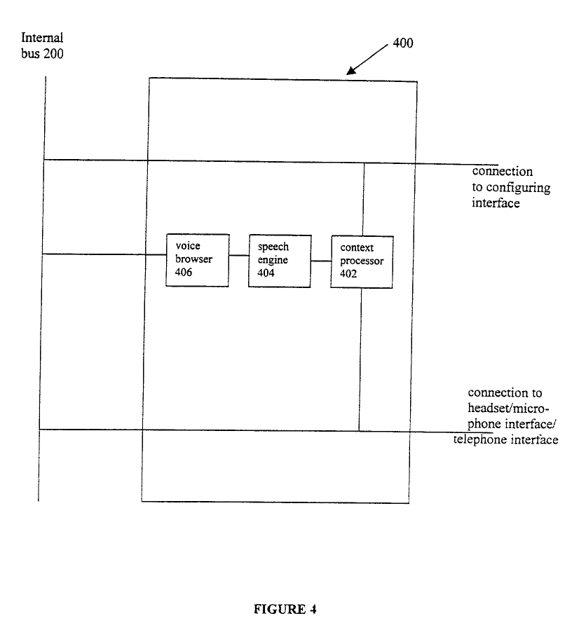

In a further preferred embodiment, the interface device 100 comprises a natural speech processor, shown generally by reference numeral 400 in FIG. 3. The natural speech processor 400 is illustrated in more detail in FIG. 4.

The natural speech processor 400 provides for natural speech conversion at a location near the user device 10, such as a telephone unit or a stereo headset and microphone. The natural speech processor 400 converts communication signals in natural language into computer recognizable language, such as hypertext mark up language (HTML) or extended mark up language (XML). Likewise, the natural speech processor 400 can convert computer recognizable language received through the ATM network 18 into natural language that can then be outputted to a telephone or headset. One advantage to this device is that the natural speech processor 400 is located proximate the user device 10 and in fact, immediately before the input/output unit 300 to the user device 100. As illustrated in FIG. 3, the natural speech processor 400 is located immediately before the self-configuring telephone interface 303 and the headset/microphone interface and codec 302.

As illustrated in FIG. 4, the natural speech processor 400 comprises a context processor 402, a speech engine 404 and a voice browser 406. The natural speech processor 400 also comprises a connection to the internal bus 200. The natural speech processor 400 also permits independent connection of the self configuring telephone interface 303 and the headset/microphone interface and codec 302 to the internal bus 200 so that communication signals which are not to be converted to computer recognizable language can be sent directly onto the internal bus 200.

The context processor extracts the “context” of the natural language communication signals uttered by the user and received through the self-configuring telephone interface 303 or the headset/microphone interface and codec 302. Once the context is extracted, the speech engine 404 converts the extracted context into computer recognizable language. The natural speech processor 400 also comprises a voice browser 406 that is essentially a database of terms that the speech engine 404 can search to assist in converting natural language to computer recognizable language. The computer recognizable communication signals can then be transferred to the internal bus 200 from the natural speech processor 400. It is understood that the natural speech processor 400 is bidirectional in that it can operate in the opposite direction to convert computer recognizable language to natural language. The converted natural language communication signals will be sent from the natural speech processor 400 to one of the input/output units 302, 303 for interfacing with the telephone or headset.

It is understood that while the present invention has been described with respect to a particular type of network, namely an ATM network, the present invention is not restricted to use with this particular type of network. Rather, the present invention can be used with any type of network 18. For instance, other networks 18 which could be used include an Ethernet network. In this embodiment, the microprocessor 210 would communicate data through a connection such as the Ethernet connection 314 shown in FIG. 3. In this embodiment, preferably, the network 18 would be an IP with Multi Protocol Label Switching(MPLS) over Ethernet.

It is further understood that while the present invention has been described with respect to a particular type of bus for a workstation, namely PCI computer bus interface 260, the invention is not limited to this type of interface bus 260. Rather, the present invention could operate with a workstation of a personal computer (not shown) having any type of computer interface bus, and not necessarily a PCI computer bus interface 260 as shown in FIG. 3. For instance, the workstation of a personal computer (not shown) could have a PCMCIA PCI-X, RapidIO, 3GIO or HyperTransport Bus. Furthermore, a work station or notebook computer could also optionally be connected to the interface device through the USB Video 310 connection, such as through a USB 2.0 connection which can send 120 Mbit/s to 240 Mbit/s.

It is further understood that while the present invention has been described with respect to a particular type of bus for video, namely USB 310, the invention is not limited to this type of video interface 310. Rather, the present invention could operate with another type of video interface (not shown) and not necessarily a USB interface 310 as shown in FIG. 3. For instance, a video camera could have a Firewire interface.

It will be understood that, although various features of the invention have been described with respect to one or another of the embodiments of the invention, the various features and embodiments of the invention may be combined or used in conjunction with other features and embodiments of the invention as described and illustrated herein.

Although this disclosure has described and illustrated certain preferred embodiments of the invention, it is to be understood that the invention is not restricted to these particular embodiments. Rather, the invention includes all embodiments that are functional, electrical or mechanical equivalents of the specific embodiments and features that have been described and illustrated herein.

The embodiments of the invention in which an exclusive property or privilege is claimed are defined as follows:

1. An interface device for interfacing a user device to an asynchronous transfer mode (ATM) network, said interface device comprising:
a user input/output unit for receiving and sending user communication signals to and from the user device;
an ATM network input/output unit for receiving and sending network signals to and from the ATM network;
a microprocessor for converting said user signals to network signals and converting network signals to user signals; and
wherein the interface device is powered by a power source which is not dependent on the user device or the ATM network.

2. The interface device as defined in claim 1 wherein the user device is selected from a group comprising analog telephones and digital telephones; and
wherein the interface device further comprises self-configuring units for configuring the interface device to detect the type of user device connected to the interface device and send and receive user signals configured for the type of user device.

3. The interface device as defined in claim 1 wherein the user device comprises a type of telephone selected from the group of telephones comprising analog telephones and digital telephones; and
wherein the interface device comprises a self-configuring unit for detecting the type of telephone connected to the interface device and configuring the user input/output unit to send and receive user signals to and from the type of telephone in a format corresponding to the type of telephone.

4. The interface device as claimed in claim 3 wherein the user device further comprises a device selected from the group comprising digital video cameras, microphones, headsets and personal computers.

5. The interface device as defined in claim 1 wherein the power source can be an electrical connection to an electrical main outlet or a battery power source.

6. The interface device as defined in claim 1 further comprising:
a natural speech processor located between the user input/output unit and the microprocessor for selectively converting communication signals in natural language from a user device connected to the user input/output unit into computer recognizable language and transferring the computer recognizable language to the microprocessor and to and from the ATM network.

7. The interface device as defined in claim 6 wherein the natural speech processor selectively converts communication signals in computer recognizable language to natural language, and, transfers the natural language communication signal to the user device connected to the user input/output unit.

8. The interface device as defined in claim 1 wherein the interface device also comprises a tri-state bus.

9. The interface device as defined in claim 1 further comprising:
an internal bus for connecting the microprocessor to the user input/output unit and the ATM network input/output; and
wherein the microprocessor monitors data transactions on the network connection for transactions which are unusual.

10. The device as defined in claim 9 wherein the microprocessor takes an action when a transaction that is unusual is detected, said action selected from the group consisting of sending a signal to an administrator of the network, and, disconnecting a port to which the unusual transaction is directed.

11. An interface device for interfacing a user device to a network, said interface device comprising:
a user input/output unit for receiving and sending user communication signals to and from the user device;
network input/output unit for receiving and sending network signals to and from the network;
a microprocessor for converting said user signals to network signals and converting network signals to user signals; and
wherein the interface device is powered by a power source which is not dependent on the user device or the network.

12. The interface device as defined in claim 11 wherein the user device is selected from a group comprising analog telephones and digital telephones; and
wherein the interface device further comprises self-configuring units for configuring the interface device to detect the type of user device connected to the interface device and send and receive user signals configured for the type of user device.

13. The interface device as defined in claim 11 wherein the user device comprises a type of telephone selected from the group of telephones comprising analog telephones and digital telephones; and
wherein the interface device comprises a self-configuring unit for detecting the type of telephone connected to the interface device and configuring the user input/output unit to send and receive user signals to and from the type of telephone in a format corresponding to the type of telephone.

14. The interface device as claimed in claim 13 wherein the user device further comprises a device selected from the group comprising digital video cameras, microphones, headsets and personal computers.

15. The interface device as defined in claim 11 wherein the power source can be an electrical connection to an electrical main outlet or a battery power source.

16. The interface device as defined in claim 11 further comprising:
a natural speech processor located between the user input/output unit and the microprocessor for selectively converting communication signals in natural language from a user device connected to the user input/output unit into computer recognizable language and transferring the computer recognizable language to the microprocessor and to and from the network.

17. The interface device as defined in claim 16 wherein the natural speech processor selectively converts communication signals in computer recognizable language to natural language, and, transfers the natural language communication signal to the user device connected to the user input/output unit.

18. The interface device as defined in claim 11 wherein the interface device also comprises a tri-state bus.

19. The interface device as defined in claim 11 further comprising:
an internal bus for connecting the microprocessor to the user input/output unit and the network input/output; and
wherein the microprocessor monitors data transactions on the network connection for transactions which are unusual.

20. The device as defined in claim 19 wherein the microprocessor takes an action when a transaction that is unusual is detected, said action selected from the group consisting of sending a signal to an administrator of the network, disconnecting a port to which the unusual transaction is directed.
